(19) United States
(12) Patent Application Publication
(10) Pub. No.: US 2016/0006581 A1
(43) Pub. Date: Jan. 7, 2016

(54) MULTICAST FORWARDING ENTRY COMPUTING

(71) Applicant: HANGZHOU H3C TECHNOLOGIES CO., LTD., Hangzhou, Zhejiang (CN)

(72) Inventors: Wenyu ZOU, Beijing (CN); Xiaoqiang TIAN, Beijing (CN)

(21) Appl. No.: 14/768,718

(22) PCT Filed: Feb. 11, 2014
(86) PCT No.: PCT/CN2014/071943

§ 371 Date: Aug. 18, 2015

(30) Foreign Application Priority Data
Mar. 13, 2013 (CN) 201310079952.2

(51) Int. Cl. H04L 12/46; H04L 12/761; H04L 12/18

(52) U.S. Cl. CPC H04L 12/4625; H04L 12/4641; H04L 12/18; H04L 45/16

(57) ABSTRACT

According to an example, a multicast forwarding entry in a TRILL network may be processed through obtaining a corresponding relationship between a root RB and a VLAN. One VLAN may correspond to one root RB. The multicast forwarding entry of the VLAN corresponding to the root RB of a multicast distribution tree may be computed according to the corresponding relationship between the root RB and the VLAN.

### BACKGROUND

Transparent Interconnection of Lots of Links (TRILL) is an Internet Engineering Task Force (IETF) standard that modifies a layer 2 (L2) network with an Intermediate System-to-Intermediate System (IS-IS) design idea of a layer 3 (L3) routing technology. The simplicity and the flexibility of the L2 network and stability, extensibility and high performance of the L3 network are combined together in TRILL.

A TRILL network is an L2 network with Routing Bridges (RBs). A bridge device running the TRILL protocol is an RB, also referred to as RBridge. The RBs may be divided into an Ingress RB, a Transit RB and an Egress RB. The Ingress RB denotes a node, through which a packet is sent to the TRILL network. The Transit RB denotes a node passed by the packet in the TRILL network. The Egress RB denotes a node, through which the packet is sent out of the TRILL network. The address of the RB in the TRILL network is a NickName. The NickName is the unique identification of the RB in the TRILL network. The NickName is automatically allocated by the system.

### BRIEF DESCRIPTION OF THE DRAWINGS

FIG. 1 is a flow chart illustrating a method for processing a multicast forwarding entry in a TRILL network in accordance with an example of the present disclosure;

FIG. 2 is a flow chart illustrating a method for processing a multicast forwarding entry in a TRILL network in accordance with an example of the present disclosure;

FIG. 3 is a schematic diagram illustrating a format of a Tree Identifiers and Interested VLANs Sub-TLV field in a Link State Protocol Data Unit (PDU) (LSP) packet in accordance with an example of the present disclosure;

FIG. 4 is a schematic diagram illustrating a format of an Appointment Information field in FIG. 3;

FIG. 5 is a schematic diagram illustrating structure of an RB in a TRILL network in accordance with an example of the present disclosure; and

FIG. 6 is a schematic diagram illustrating hardware architecture of an RB in a TRILL network in accordance with an example of the present disclosure.

### DETAILED DESCRIPTION

For simplicity and illustrative purposes, the present disclosure is described by referring mainly to non-limiting examples. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure. As used throughout the present disclosure, the term “includes” means includes but not limited to, the term “including” means including but not limited to. The term “based on” means based at least in part on. In addition, the terms “a” and “an” are intended to denote at least one of a particular element.

In a TRILL network, a multi-destination packet may be forwarded by a multicast distribution tree. The multi-destination packet is a packet sent to multiple receivers. Multi-destination packets include a unicast packet, in which a destination Media Access Control (MAC) address is unknown, a multicast packet and a broadcast packet.

In the TRILL network, the NickName of each RB is taken as a tree root priority of the each RB. Tree root priorities of all RBs are sorted. The RB with the highest tree root priority broadcasts a link state packet (LSP packet) carrying a Tree Identifiers Sub-Type Length Value (TLV) field. The Tree Identifiers Sub-TLV denotes the NickName of the root RB of the multicast distribution tree (the root RB is taken as the RB of the tree root of the multicast distribution tree). RBs may compute multicast forwarding entries according to the NickName of the root RB of the multicast distribution tree. After receiving the LSP packet, each RB computes paths of the multicast distribution tree corresponding to each root RB according to the Tree Identifiers Sub-TLV field in the LSP packet. Furthermore, each RB computes a multicast forwarding entry. Different methods may be used to compute the multicast forwarding entry. One method includes computing a multicast forwarding entry according to each multicast distribution tree. A second one includes computing a multicast forwarding entry according to each Virtual Local Area Network (VLAN) on each multicast distribution tree. A third one includes computing a multicast forwarding entry according to each multicast MAC address of each VLAN on each multicast distribution tree. Therefore, the multi-destination packet may be forwarded according to the root RB, or the root RB and the VLAN, or the root RB, VLAN and multicast MAC address.A corresponding relationship between the root RB, the VLAN and the multicast MAC address of the multicast distribution tree may be created by each Ingress RB according to a preset rule. When a multi-destination packet from a local user network is received, an Ingress RB finds a corresponding root RB corresponding to a VLAN in the multi-destination packet according to the above corresponding relationship, encapsulates the multi-destination packet into a TRILL packet according to the root RB and sends out the TRILL packet. Since the corresponding relationship between the root RB, VLAN and multicast MAC address created by each Ingress RB may be different, each Transit RB or Egress RB computes the multicast forwarding entry. One method includes computing a multicast forwarding entry according to the root RB on each multicast distribution tree. A second method includes computing a multicast forwarding entry according to the root RB and the VLAN on each multicast distribution tree. A third method includes computing a multicast forwarding entry according to the root RB, VLAN and the multicast MAC address on each multicast distribution tree. Therefore, no matter the received TRILL packet is encapsulated by which root RB, the Transit RB or the Egress RB may find a corresponding multicast forwarding entry. Therefore, the multi-destination packet may be correctly forwarded, invalid forwarding may be avoided and the bandwidth may be saved.

In a large TRILL network, multiple multicast distribution trees may be configured to implement load sharing of data streams. Multiple VLANs are configured for a multicast distribution tree and multiple multicast MAC addresses are configured for each VLAN. Therefore, in order to normally forward the multi-destination packet, each RB computes a large number of multicast forwarding entries. As for the same VLAN, the multicast forwarding entry of the root RB and the VLAN should be computed on each multicast distribution tree. As for the same multicast MAC address, the multicast forwarding entry of the root RB, VLAN and multicast MAC address should be computed on each multicast distribution tree. Therefore, a lot of entry resources are wasted.

The present disclosure provides examples of methods for processing a multicast forwarding entry in a TRILL network and an RB which may use the methods. As further described below, the number of the computed multicast forwarding entries may be effectively reduced and entry resources may be saved according to the examples of the method.

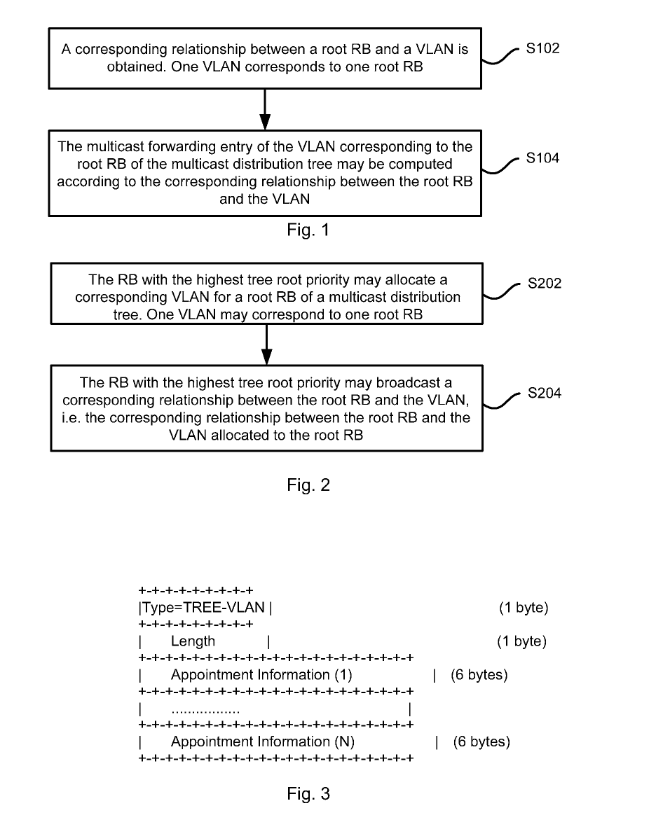

According to an example, the method for processing the multicast forwarding entry in the TRILL network may be executed by an RB in the TRILL network. As shown in FIG. 1, the method includes the following blocks.

At block S102, a corresponding relationship between a root RB and a VLAN is obtained. One VLAN corresponds to one root RB. In one example, one VLAN corresponds to (e.g., is assigned to) only one root RB.

In the TRILL network, a NickName priority of an RB is taken as a tree root priority of the RB. Tree root priorities of all RBs are sorted. An RB with the highest tree root priority broadcasts the NickName of the root RB of the multicast distribution tree. RBs may compute multicast forwarding entries according to the NickName of the root RB of the multicast distribution tree.

According to an example, all RBs in the multicast distribution tree may compute the multicast forwarding entries. In this example, the RB with the highest tree root priority may allocate a corresponding VLAN for the root RB of the multicast distribution tree. One VLAN corresponds to one root RB. The RB with the highest tree root priority may also broadcast the corresponding relationship between the root RB and the VLAN (i.e., the corresponding relationship between the root RB and the VLAN allocated to the RB). The VLAN is a whole network VLAN.

The RB with the highest tree root priority may create the corresponding relationship between the root RB and the VLAN. Other RBs except for the RB with the highest tree root priority may obtain the corresponding relationship from the RB with the highest tree root priority.

The RB with the highest tree root priority may broadcast the NickName of the root RB of the multicast distribution tree and the corresponding relationship between the root RB and the VLAN via a LSP packet. RBs may compute multicast forwarding entries according to the NickName of the root RB of the multicast distribution tree.

After other RBs receive the LSP packet, the RBs may compute paths of the multicast distribution tree corresponding to the root RB indicated by the NickName in the LSP packet and save the corresponding relationship between the root RB and the VLAN in the LSP packet, so that the multicast forwarding entry may be computed in the following block S104.

At block S104, the multicast forwarding entry of the VLAN corresponding to the root RB of the multicast distribution tree may be computed according to the corresponding relationship between the root RB and the VLAN.

In this block S104, the multicast forwarding entry of the VLAN corresponding to the root RB of the multicast distribution tree may be computed according to the corresponding relationship between the root RB and the VLAN via at least one of following methods.

Method one: on a multicast distribution tree, the multicast forwarding entry may be computed according to the root RB of the multicast distribution tree and the multicast forwarding entry including the root RB may be obtained.

Method two: on a multicast distribution tree, the multicast forwarding entry may be computed according to the VLAN corresponding to the root RB of the multicast distribution tree and the multicast forwarding entry including the root RB and the VLAN corresponding to the root RB may be obtained.

According to an example, as for each multicast distribution tree, VLANs of all RBs on the multicast distribution tree may be determined. As for a VLAN, the root RB corresponding to the VLAN may be found according to the corresponding relationship between the root RB and the VLAN, and a determination is made as to whether the root RB corresponding to the VLAN is the root RB of the multicast distribution tree. If the root RB corresponding to the VLAN is the root RB of the multicast distribution tree, the multicast forwarding entry of the root RB and the VLAN may be computed according to the VLAN on the multicast distribution tree. If the root RB corresponding to the VLAN is not the root RB of the multicast distribution tree, the multicast forwarding entry of the root RB and the VLAN is not computed.

As for the same VLAN, the multicast forwarding entry of the root RB and VLAN may be computed on the multicast distribution tree corresponding to the VLAN. Multicast forwarding entries need not be computed on other multicast forwarding trees.

Method three: on a multicast distribution tree, the multicast forwarding entry may be computed according to a multicast MAC address of a VLAN corresponding to the root RB of the multicast distribution tree. The multicast forwarding entry including the root RB, the VLAN corresponding to the root RB and the multicast MAC address corresponding to the VLAN may be obtained.

According to an example, on a multicast distribution tree, VLANs of all RBs on the multicast distribution tree may be determined. As for a VLAN, the root RB corresponding to the VLAN may be found according to the corresponding relationship between the root RB and the VLAN, and a determination is made as to whether the root RB corresponding to the VLAN is the root RB of the multicast distribution tree. If the root RB corresponding to the VLAN is the root RB of the multicast distribution tree, the multicast forwarding entry of the root RB, VLAN and multicast MAC address may be computed on the multicast distribution tree according to a multicast MAC address of the VLAN. If the root RB corresponding to the VLAN is not the root RB of the multicast distribution tree, the multicast forwarding entry of the root RB, VLAN and multicast MAC address is not computed.

Therefore, as for the same multicast MAC address, the multicast forwarding entry of the root RB, VLAN and multicast MAC address may be computed on the multicast distribution tree corresponding to the VLAN of the multicast MAC address. Multicast forwarding entries need not be computed on other multicast distribution trees.

According to an example, the RB with the highest tree root priority may broadcast the corresponding relationship between a root RB of a multicast distribution tree and a VLAN. The RB with the highest tree root priority may broadcast the corresponding relationship between a root RB of a multicast distribution tree and a VLAN. One VLAN corresponds to one root RB.

After an RB receives the corresponding relationship, the RB computes the multicast forwarding entry on the multicast distribution tree. The multicast forwarding entry of the VLAN corresponding to the root RB of the multicast distribution tree is computed. Also, the multicast forwarding entry of the RB and VLAN is computed or the multicast forwarding entry of the root RB, VLAN and the multicast MAC address may be computed according to the corresponding relationship. Since one VLAN corresponds to one root RB, as for the same VLAN, the multicast forwarding entry of the root RB and VLAN may be computed on the multicast distribution tree corresponding to the VLAN. As for the same multicast MAC address, the multicast forwarding entry of the RB, VLAN and multicast MAC address may be computed on the multicast distribution tree corresponding to the VLAN of the multicast MAC address. Therefore, the number of the computed multicast forwarding entries may be effectively reduced and entry resources may be saved.

Furthermore, when an RB is an Ingress RB, after the RB receives the corresponding relationship between the root RB and the VLAN from the RB with the highest tree root priority at block S102, the RB may create a corresponding relationship between the root RB of the multicast distribution tree, the VLAN and the multicast MAC address according to the received corresponding relationship between the root RB and the VLAN. In the created corresponding relationship, the corresponding relationship between the root RB and the VLAN is the same as the received corresponding relationship between the root RB and the VLAN. After the RB receives an Ethernet packet from a local user network, the RB may search for the root RB corresponding to the VLAN in the Ethernet packet according to the created corresponding relationship, encapsulate the Ethernet packet according to the NickName of the root RB into a TRILL packet and send out the TRILL packet. The corresponding relationship between the root RB and the VLAN may be defined by the RB with the highest tree root priority and one VLAN may correspond to one root RB. The Ingress RB may create the corresponding relationship between the root RB, the VLAN and the multicast MAC address according to the corresponding relationship between the root RB and the VLAN sent from the RB with the highest tree root priority. Therefore, a multi-destination packet of a VLAN may be encapsulated into the TRILL packet with the NickName of the root RB corresponding to the VLAN and the TRILL packet may be forwarded in the TRILL network. When the Transit RB or the Egress RB may compute the multicast forwarding entry according to the corresponding relationship between the root RB and the VLAN sent from the RB with the highest tree root priority. Therefore, after the Transit RB or the Egress RB receives the TRILL packet from the Ingress RB, the Transit RB or the Egress RB may correctly forward the TRILL packet via searching the multicast forwarding entry.

FIG. 2 is a flow chart illustrating a method for processing a multicast forwarding entry in a TRILL network in accordance with another example of the present disclosure.

According to an example, when an RB is an RB with the highest tree root priority, the RB may execute the following blocks.

At block S202, the RB with the highest tree root priority may allocate a corresponding VLAN for a root RB of a multicast distribution tree. One VLAN may correspond to one root RB. In one example, one VLAN corresponds to (e.g., is assigned to) only one root RB.

At block S204, the RB with the highest tree root priority may broadcast a corresponding relationship between the root RB and the VLAN, i.e. the corresponding relationship between the root RB and the VLAN allocated to the root RB.

According to an example, the RB with the highest tree root priority may broadcast the NickName of the root RB of the multicast distribution tree. RBs may compute multicast forwarding entries according to the NickName of the root RB of the multicast distribution tree. In addition, the RB with the highest tree root priority may broadcast the corresponding relationship between the root RB and the VLAN allocated to the root RB. The RB with the highest tree root priority may broadcast the NickName of the root RB of the multicast distribution tree and the corresponding relationship between the root RB and the VLAN via an LSP packet. RBs may compute multicast forwarding entries according to the NickName of the root RB of the multicast distribution tree.

For example, a Tree Identifiers and Interested VLANs Sub-TLV field may be added to a Router Capability TLV field of the LSP packet. The format of the Tree Identifiers and Interested VLANs Sub-TLV is shown in FIG. 3. The meaning of each field in the Tree Identifiers and Interested VLANs Sub-TLV field shown in FIG. 3 is now described.

Type: if the value of the Type is a first value (denoted as TREE-VLAN in FIG. 3), it may represent that the TLV may be the Tree Identifiers and Interested VLANs Sub-TLV. The length of the field may be one byte.

Length may be used for carrying the length of a Value field, i.e. total length of all Appointment Information fields, except for the Type field and the Length field in the Tree Identifiers and Interested VLANs Sub-TLV field. The length of the Value field may be one byte.

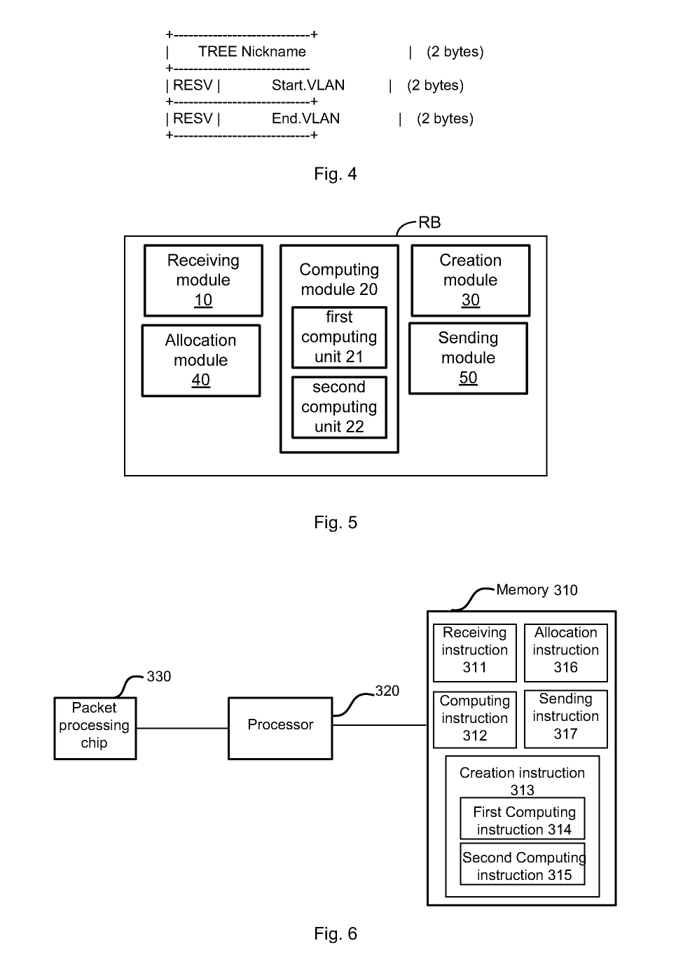

Appointment Information may carry the root RB of the multicast distribution tree and the VLAN corresponding to the root RB. The length of the field may be six bytes. The format of the field may be shown in FIG. 4. The meaning of each field is as follows.

TREE NickName may carry a NickName of a root RB of a multicast distribution tree. The length of the field may be two bytes.

RESV may be a reservation field.

Start. VLAN and End.VLAN may respectively carry a starting value and an ending value of the VLAN corresponding to the root RB. A VLAN between the starting VLAN and the ending VLAN may be the VLAN corresponding to the root RB. For example, assume that the staring VLAN is VLAN 10 and the ending VLAN is VLAN 30, any VLAN in [VLAN 10, VLAN 30] may correspond to the root RB.

The NickName of the root RB of the multicast distribution tree and the corresponding relationship between the root RB and the VLAN may be carried in the LSP packet with other methods. RBs may compute multicast forwarding entries according to the NickName of the root RB of the multicast distribution tree.

FIG. 5 shows an example of an RB that includes a receiving module 10 and computing module 20. The RB may implement the methods described herein.

The receiving module 10 may obtain a corresponding relationship between a root RB and a VLAN. One VLAN corresponds to one root RB.

The computing module 20 may compute a multicast forwarding entry of the VLAN corresponding to the root RB on a multicast distribution tree according to the corresponding relationship between the root RB and the VLAN.

In addition, when the RB is an Ingress RB, the RB may further include a creation module 30 to create a corresponding relationship between the root RB of the multicast distribution tree, the VLAN and a multicast MAC address according to the corresponding relationship between the root RB and the VLAN obtained by the receiving module 10.

In order to compute the multicast forwarding entry of the VLAN corresponding to the root RB on the multicast distribution tree according to the corresponding relationship between the root RB and the VLAN, the computing module 20 may further include at least one of a first computing unit 21 and a second computing unit 22.

The first computing unit 21 may compute the multicast forwarding entry on the multicast distribution tree according to the VLAN corresponding to the root RB of the multicast distribution tree, obtain the multicast forwarding entry including the root RB and the VLAN corresponding to the root RB and obtain the multicast forwarding entry of the root RB and the VLAN.

The second computing unit 22 may compute the multicast forwarding entry on a multicast distribution tree according to a multicast MAC address of the VLAN corresponding to the root RB of the multicast distribution tree, obtain the multicast forwarding entry including the root RB, the VLAN corresponding to the root RB and the multicast MAC address corresponding to the VLAN and obtain the multicast forwarding entry of the root RB, VLAN and the multicast MAC address.

When the RB is the RB with the highest tree root priority, the RB may further include an allocation module 40 and a sending module 50.

The allocation module 40 may allocate the VLAN for the root RB of the multicast distribution tree, so that the corresponding relationship between the root RB and the VLAN may be created. One VLAN corresponds to one root RB. The allocation module 40 may allocate the VLAN for each root RB of the each multicast distribution tree, so that the corresponding relationship between the each root RB and the each VLAN may be created.

The receiving module 10 may obtain the corresponding relationship from the allocation module.

The sending module 50 may broadcast the corresponding relationship between the root RB and the VLAN.

According to an example, the corresponding relationship between the root RB and the VLAN may be sent out via an LSP packet.

According to an example, the modules and units in the RB may be integrated together or deployed separately. In addition, the modules and units in the RB may be combined into a module or unit or split into multiple sub-modules or sub-units. In examples of the present disclosure, modules or units may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also include programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

An example of a hardware architecture of the RB shown in FIG. 5 is shown in FIG. 6. The RB shown in FIG. 6 may be a programmable device including software and hardware. The RB includes a memory 310, a processor 320 and a packet processing chip 330.

The memory 310 is to store machine readable instructions for the modules and units shown in FIG. 5. The instructions are stored in a non-transitory computer readable medium. As shown in FIG. 6, the instructions may include a receiving instruction 311 and a computing instruction 312.

The processor 320 may communicate with the memory 310 and execute the receiving instruction 311 in the memory 310, to obtain a corresponding relationship between a root RB and VLAN via a packet processing chip 330. One VLAN corresponds to one root RB.

The processor 320 may execute the computing instruction 312 to compute a multicast forwarding entry of the VLAN corresponding to the root RB of a multicast distribution tree according to the corresponding relationship between the root RB and the VLAN.

When the RB is an Ingress RB, the memory may further store a creation instruction 313. The processor 320 may execute the creation instruction 313 to create a corresponding relationship between the root RB, the VLAN and a multicast MAC address according to the corresponding relationship between the root RB and the VLAN.

The creation instruction 313 may include a first computing instruction 314 and a second computing instruction 315. The processor 320 may execute the first computing instruction 314 to compute the multicast forwarding entry of the VLAN corresponding to the root RB of the multicast distribution tree and obtain the multicast forwarding entry including the root RB and the VLAN corresponding to the root RB. The processor 320 may execute the second computing instruction 315 to compute the multicast forwarding entry according to a multicast MAC address of the VLAN corresponding to the root RB of the multicast distribution tree and obtain the multicast forwarding entry including the root RB, the VLAN corresponding to the root RB and the multicast MAC address corresponding to the VLAN.

When the RB is the RB with the highest tree root priority, the memory 310 may further include an allocation instruction 316 and a sending instruction 317. The processor 320 may execute the allocation instruction 316 to allocate a VLAN for a root RB of a multicast distribution tree, so that the corresponding relationship between the root RB and the VLAN may be established. The processor 320 may execute the sending instruction 317 to send out the corresponding relationship between the root RB and the VLAN via the packet processing chip 330. When the RB is not the RB with the highest tree root priority, the processor 320 may further execute the receiving instruction 311 to receive the corresponding relationship between the root RB and the VLAN from the RB with the highest tree root priority.

The packet processing chip 330 may connect with other RBs in the TRILL network and devices in the user network via ports on the packet processing chip 330 and send a packet carrying the corresponding relationship between the root RB and the VLAN to the processor 320. When the RB is the RB with the highest tree root priority, the packet processing chip 330 may send out a packet from the processor 320 carrying the corresponding relationship between the RB and the VLAN.

The RB shown in FIG. 6 may be implemented via different structure. For example, the operations performed by executing the above instructions may be implemented by a dedicated ASIC. In addition, in the above example, one or multiple processors 320 may be used. If there are multiple processors, the multiple processors cooperate with each other to read and execute the instructions.

In the present disclosure, the RB with the highest tree root priority may broadcast the corresponding relationship between the root RB and the VLAN. One VLAN may correspond to one root RB. After an RB receives the corresponding relationship, when the RB computes the multicast forwarding entry on the multicast distribution tree, the multicast forwarding entry of the VLAN corresponding to the root RB of the multicast distribution tree, the multicast forwarding entry of the RB and VLAN or the multicast forwarding entry of the root RB, VLAN and the multicast MAC address may be computed according to the corresponding relationship. Since one VLAN corresponds to one root RB, as for the same VLAN, the multicast forwarding entry of the root RB and VLAN may be computed on the multicast distribution tree corresponding to the VLAN. As for the same multicast MAC address, the multicast forwarding entry of the RB, VLAN and multicast MAC address may be computed on the multicast distribution tree corresponding to the VLAN of the multicast MAC address. Therefore, the number of the computed multicast forwarding entries may be effectively reduced and entry resources may be saved.

What has been described and illustrated herein are examples of the disclosure along with some variations. The terms, descriptions and figures used herein are set forth by way of illustration only and are not meant as limitations. Many variations are possible within the scope of the disclosure, which is intended to be defined by the following claims—and their equivalents—in which all terms are meant in their broadest reasonable sense unless otherwise indicated.

What is claimed is:

1. A method for processing a multicast forwarding entry in a Transparent Interconnection of Lots of Links (TRILL) network, comprising:
obtaining a corresponding relationship between a root Routing Bridge (RB) and a Virtual Local Area Network (VLAN), wherein one VLAN corresponds to one root RB; and
computing a multicast forwarding entry of the VLAN corresponding to the root RB of a multicast distribution tree according to the corresponding relationship between the root RB and the VLAN.

2. The method according to claim 1, wherein when the RB is an Ingress RB, the method further comprises:
creating a corresponding relationship between the root RB of the multicast distribution tree, the VLAN and a multicast Media Access Control (MAC) address according to the corresponding relationship between the root RB and the VLAN.

3. The method according to claim 1, wherein computing the multicast forwarding entry of the VLAN corresponding to the root RB of the multicast distribution tree according to the corresponding relationship between the root RB and the VLAN comprises:
computing the multicast forwarding entry according to the VLAN corresponding to the root RB of the multicast distribution tree and obtaining the multicast forwarding entry including the root RB and the VLAN corresponding to the root RB; or
computing the multicast forwarding entry according to a multicast MAC address of the VLAN corresponding to the root RB of the multicast distribution tree and obtaining the multicast forwarding entry comprising the root RB, the VLAN corresponding to the root RB and the multicast MAC address corresponding to the VLAN.

4. The method according to claim 1, wherein when the RB is an RB with the highest tree root priority, obtaining the corresponding relationship between the root RB and the VLAN comprises: creating the corresponding relationship between the root RB and the VLAN;
when the RB is not the RB with the highest tree root priority, obtaining the corresponding relationship between the root RB and the VLAN comprises:
obtaining the corresponding relationship between the root RB and the VLAN from the RB with the highest tree root priority.

5. The method according claim 1, wherein the corresponding relationship between the root RB and the VLAN is sent out via a Link State Protocol Data Unit packet.

6. An RB in a TRILL network, comprising: a memory, a processor and a packet processing chip, wherein
the memory is to store a receiving instruction and a computing instruction,
the processor communicates with the memory and executes the receiving instruction to obtain a corresponding relationship between a root RB and a VLAN via the packet processing chip, wherein one VLAN corresponds to one root RB, and
the processor further executes the computing instruction to compute a multicast forwarding entry of the VLAN corresponding to the root RB of a multicast distribution tree according to the corresponding relationship between the root RB and the VLAN.

7. The RB according to claim 6, wherein when the RB is an Ingress RB, the memory further stores a creation instruction; and
the processor is further to execute the creation instruction to create a corresponding relationship between the root RB of the multicast distribution tree, the VLAN and a multicast MAC address according to the corresponding relationship between the root RB and the VLAN.

8. The RB according to claim 6, wherein the creation instruction comprises a first computing instruction, and
the processor is further to execute the first computing instruction to compute the multicast forwarding entry according to the VLAN corresponding to the root RB of the multicast distribution tree and obtain the multicast forwarding entry including the root RB and the VLAN corresponding to the root RB.

9. The RB according to claim 8, wherein the creation instruction comprises a second computing instruction, and
the processor is further to execute the second computing instruction to compute the multicast forwarding entry according to a multicast MAC address of the VLAN corresponding to the root RB of the multicast distribution tree and obtain the multicast forwarding entry comprising the root RB, the VLAN corresponding to the root RB and the multicast MAC address corresponding to the VLAN.

10. The RB according to claim 6, wherein when the RB is an RB with the highest tree root priority, the memory further stores an allocation instruction and a sending instruction;
the processor is further to execute the allocation instruction to allocate the VLAN for the root RB of the multicast distribution tree, so that the corresponding relationship between the root RB and the VLAN is created;
the processor is further to execute the sending instruction to send out the corresponding relationship between the root RB and the VLAN via the packet processing chip;
when the RB is not the RB with the highest tree root priority, the processor is further to execute the receiving instruction to receive the corresponding relationship between the root RB and the VLAN from the RB with the highest tree root priority.

11. The RB according to claim 10, wherein the processor is further to execute the sending instruction to send out the corresponding relationship between the root RB and the VLAN via a LSP packet.

12. A non-transitory computer readable medium storing machine readable instructions executable by processing hardware to:
obtain a corresponding relationship between a root RB and a VLAN, wherein one VLAN corresponds to one root RB; and
compute a multicast forwarding entry of the VLAN corresponding to the root RB of a multicast distribution tree according to the corresponding relationship between the root RB and the VLAN.

13. The non-transitory computer readable medium of claim 12, wherein when an RB including the non-transitory computer readable medium and the processing hardware is an Ingress RB, the machine readable instructions executable by the processing hardware to:
create a corresponding relationship between the root RB of the multicast distribution tree, the VLAN and a multicast MAC address according to the corresponding relationship between the root RB and the VLAN.

14. The non-transitory computer readable medium of claim 12, wherein the machine readable instructions to compute the multicast forwarding entry of the VLAN corresponding to the root RB of the multicast distribution tree according to the corresponding relationship between the root RB and the VLAN comprise machine readable instructions to:
compute the multicast forwarding entry according to the VLAN corresponding to the root RB of the multicast distribution tree and obtaining the multicast forwarding entry including the root RB and the VLAN corresponding to the root RB; or
compute the multicast forwarding entry according to a multicast MAC address of the VLAN corresponding to the root RB of the multicast distribution tree and obtaining the multicast forwarding entry comprising the root RB, the VLAN corresponding to the root RB and the multicast MAC address corresponding to the VLAN.

15. The non-transitory computer readable medium of claim 12, wherein when an RB includes the non-transitory computer readable medium and the processing hardware is an RB with the highest tree root priority, the machine readable instructions to obtain the corresponding relationship between the root RB and the VLAN comprise machine readable instructions to: create the corresponding relationship between the root RB and the VLAN; and
when the RB is not the RB with the highest tree root priority, the machine readable instructions to obtain the corresponding relationship between the root RB and the VLAN comprise machine readable instructions to: obtain the corresponding relationship between the root RB and the VLAN from the RB with the highest tree root priority.
